(19) United States
(12) Patent Application Publication
(10) Pub. No.: US 2017/0368914 A1
(43) Pub. Date: Dec. 28, 2017

(54) REMOVABLE EXTERNAL BULKHEAD FOR TRANSPORTATION REFRIGERATION UNIT

(71) Applicant: CARRIER CORPORATION, FARMINGTON, CT (US)

(72) Inventors: Mary D. Saroka, Syracuse, NY (US); Frank A. Volino, Cicero, NY (US)

(73) Assignee: Carrier Corporation, Farmington, CT (US)

(21) Appl. No.: 15/542,388

(22) PCT Filed: Jan. 8, 2016
(86) PCT No.: PCT/US2016/012675

§ 371 Date: Jul. 7, 2017

Related U.S. Application Data
(60) Provisional application No. 62/101,635, filed on Jan. 9, 2015.

(51) Int. Cl. B60H 1/32; B60P 3/20

(52) U.S. Cl. CPC B60H 1/3229; B60H 1/3232; B60P 3/20

(57) ABSTRACT

A cover for a transportation refrigeration unit includes a substantially solid front panel and one or more airflow inlet openings located at a top of the cover to direct an airflow from outside the cover into the transportation refrigeration unit. A refrigerated container system includes a container having a cargo compartment for transportation of a cargo and a transportation refrigeration unit secured to the container and including a refrigeration unit operably connectible to the cargo compartment and configured to direct cooling airflow into the cargo compartment thereby cooling the cargo compartment to a selected temperature. A cover is secured to the refrigeration unit and includes a substantially solid front panel and one or more airflow inlet openings positioned at a top of the cover to direct an inlet airflow from outside the cover into the refrigeration unit.

### BACKGROUND

The subject matter disclosed herein relates to transportation refrigeration systems. More specifically, the present disclosure relates to managing and controlling air input into transportation refrigeration systems.

Referring to FIG. 6, on tractor-trailer applications, where a tractor 100 is coupled to and pulls a trailer 102, refrigeration units 104 for such applications (referred to as “transportation refrigeration units”) are typically mounted to a front wall of the trailer 102, so the transportation refrigeration unit 104 is positioned between the tractor 100 and the trailer 102.

The transportation refrigeration unit 104 is contained in a housing, with the housing having a mesh or grated panel 106 on its front face as an intake for air into the condenser section of the transportation refrigeration unit 104. Due to its position at the front face between the tractor 100 and trailer 102, much of the air 108 passing through the panel 106 into the condenser section is actually recirculated air from a transportation refrigeration unit outlet and/or heat from the tractor engine, both of which are of high temperature compared to ambient temperature, and as a result reduce unit performance and efficiency.

The problem is exacerbated in tractor trailer systems that are equipped with fuel saving options. These options include routing tractor engine heat underneath the tractor 100, and also aerodynamic fairings 110 positioned on a roof of the tractor 100 and/or along a side of the tractor 100. The tractor engine heat routing results in an increase in high temperature exhaust air ingested by the transportation refrigeration unit, while the aerodynamic fairings 110 divert flow of lower temperature ambient air around the transportation refrigeration unit, so that the ambient air is much less likely to reach the panel 106.

### BRIEF SUMMARY

In one embodiment, a cover for a transportation refrigeration unit includes a substantially solid front panel and one or more airflow inlet openings located at a top of the cover to direct an airflow from outside the cover into the transportation refrigeration unit.

Additionally or alternatively, in this or other embodiments, a top panel is operably connected to the front panel, the one or more airflow inlet openings positioned at the top panel.

Additionally or alternatively, in this or other embodiments the one or more airflow inlet openings include one or more scoops to direct the airflow into the transportation refrigeration unit.

Additionally or alternatively, in this or other embodiments one or more baffles are secured to the cover to direct the airflow from the one or more airflow inlet openings to a selected portion of the transportation refrigeration unit.

Additionally or alternatively, in this or other embodiments the one or more baffles are formed integral to the cover.

Additionally or alternatively, in this or other embodiments one or more airflow outlet openings are positioned below the one or more airflow inlet openings to direct the airflow from inside the transportation refrigeration unit to outside the cover.

Additionally or alternatively, in this or other embodiments one or more outlet baffles are secured to the cover to direct the airflow from the transportation refrigeration unit to the one or more airflow outlet openings.

In another embodiment, a transportation refrigeration system includes a refrigeration unit operably connectible to a cargo compartment and configured to direct cooling airflow into the cargo compartment thereby cooling the cargo compartment to a selected temperature. A cover is secured to the refrigeration unit including a substantially solid front panel and one or more airflow inlet openings positioned at a top of the cover to direct an inlet airflow from outside the cover into the refrigeration unit.

Additionally or alternatively, in this or other embodiments a top panel is operably connected to the front panel, the one or more airflow inlet openings positioned at the top panel.

Additionally or alternatively, in this or other embodiments the one or more airflow inlet openings include one or more scoops to direct the inlet airflow into the refrigeration unit.

Additionally or alternatively, in this or other embodiments one or more baffles secured to the cover to direct the inlet airflow from the one or more airflow inlet openings to a selected portion of the refrigeration unit.

Additionally or alternatively, in this or other embodiments the one or more baffles are formed integral to the cover.

Additionally or alternatively, in this or other embodiments one or more airflow outlet openings are positioned below the one or more airflow inlet openings to direct an outlet airflow from inside the refrigeration unit to outside the cover.

Additionally or alternatively, in this or other embodiments the cover is installed over a condenser air mesh of the refrigeration unit.

In yet another embodiment, a refrigerated container system includes a container having a cargo compartment for transportation of a cargo and a transportation refrigeration unit secured to the container and including a refrigeration unit operably connectible to the cargo compartment and configured to direct cooling airflow into the cargo compartment thereby cooling the cargo compartment to a selected temperature. A cover is secured to the refrigeration unit and includes a substantially solid front panel and one or more airflow inlet openings positioned at a top of the cover to direct an inlet airflow from outside the cover into the refrigeration unit.

Additionally or alternatively, in this or other embodiments the one or more airflow inlet openings include one or more scoops to direct the inlet airflow into the refrigeration unit.

Additionally or alternatively, in this or other embodiments one or more baffles are secured to the cover to direct the inlet airflow from the one or more airflow inlet openings to a selected portion of the refrigeration unit.

Additionally or alternatively, in this or other embodiments the one or more baffles are formed integral to the cover.

Additionally or alternatively, in this or other embodiments one or more airflow outlet openings are positioned below the one or more airflow inlet openings to direct an outlet airflow from inside the refrigeration unit to outside the cover.

Additionally or alternatively, in this or other embodiments the cover is installed over a condenser air mesh of the refrigeration unit.

### BRIEF DESCRIPTION OF THE DRAWINGS

FIG. 1 is a side view of an embodiment of a tractor-trailer system with a transportation refrigeration unit;

FIG. 2 is a perspective view of an embodiment of a transportation refrigeration unit;

FIG. 3 is a cross-sectional view of an embodiment of an airflow inlet for a transportation refrigeration unit;

FIG. 4 is a partially exploded view of an embodiment of a transportation refrigeration unit;

FIG. 5 is a side view of an embodiment of a transportation refrigeration unit; and

FIG. 6 is a side view of a prior tractor-trailer system.

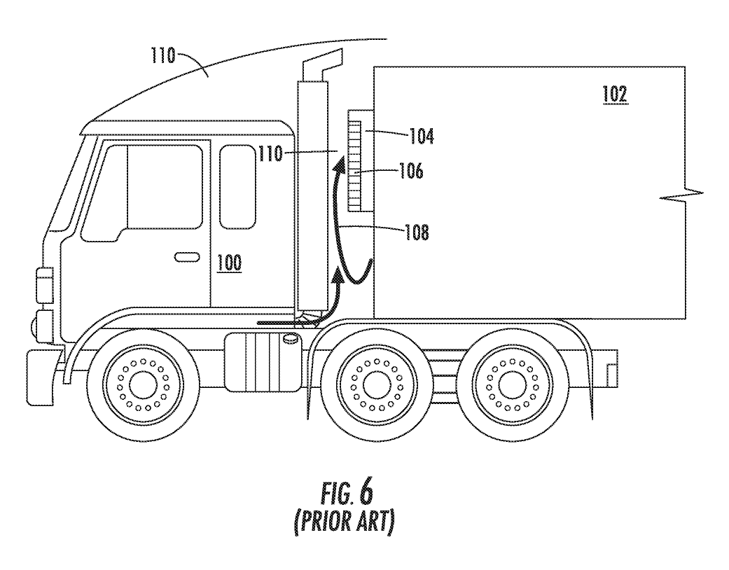

The detailed description explains the invention, together with advantages and features, by way of examples with reference to the drawings.

### DETAILED DESCRIPTION

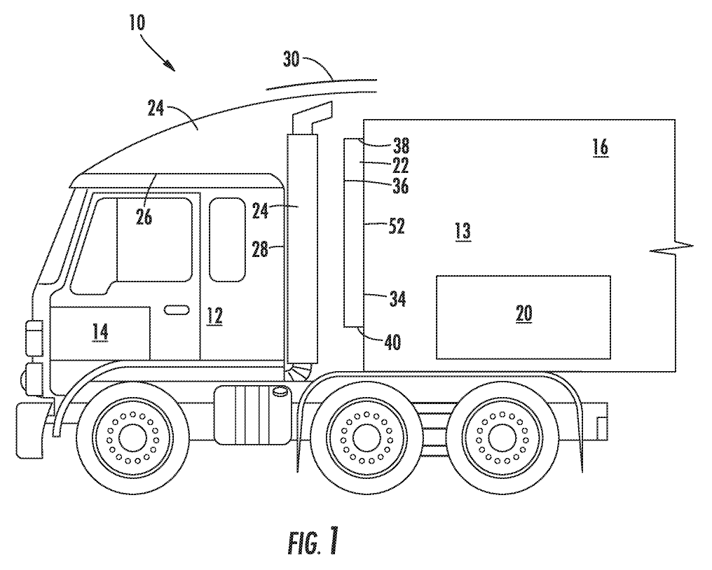

Shown in FIG. 1 is an exemplary embodiment of a tractor-trailer system 10. The system includes a tractor 12, or cab, which includes an engine 14 to drive the system 10, and compartment for the operator (not shown). The tractor 12 is coupled to a trailer 16, which includes a cargo compartment 18 to transport a cargo 20. A transportation refrigeration unit (TRU) 22 is coupled to the trailer 16 and provides cooling airflow into the cargo compartment 18 to maintain the cargo 20 at a selected temperature. While the term “trailer” is used throughout this description, one skilled in the art will readily appreciate that the subject matter disclosed herein may be applied to other refrigerated cargo container systems. The TRU 22 includes components typical of such a device, such as a compressor, a condenser, an expansion device and an evaporator that operate on a flow of refrigerant circulating through the TRU 22. In some embodiments, since tractor fuel consumption is a main driver in the cost of operating a tractor-trailer system 10, the tractor-trailer system 10 may include aerodynamic devices fixed to that tractor 12 and/or the trailer 16. These devices may include aerodynamic fairings 24 fixed to a roof 26 of the tractor 12 and/or fixed to a side 28 of the tractor 12 as shown in FIG. 1. It is to be appreciated, however, that the shown fairings 24 are merely exemplary, and fairings 24 of other shapes/sizes/locations may be utilized. The fairings 24 are configured to direct ambient airflow 30 around the tractor-trailer system 10 smoothly, thereby reducing fuel consumption.

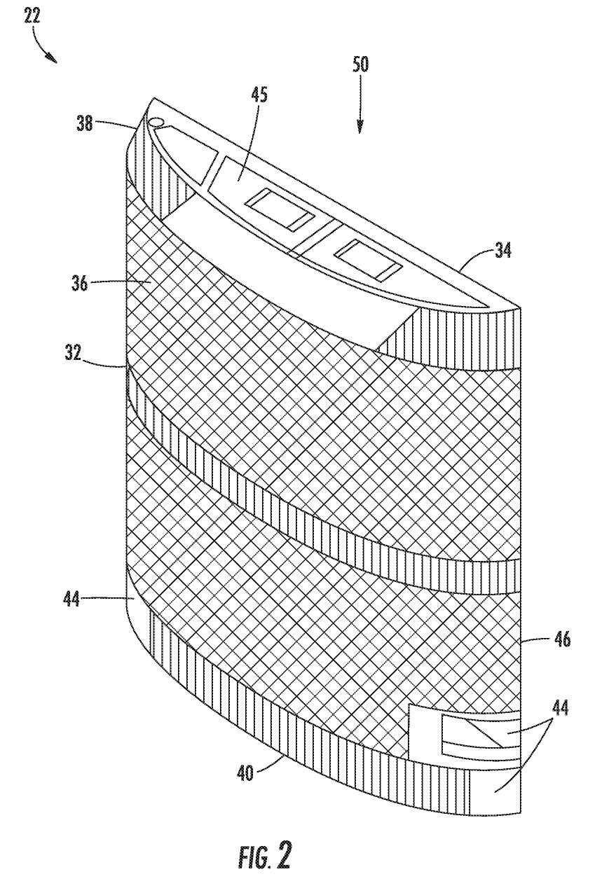

Referring to FIG. 2, the TRU 22 is contained in a housing 32 at a front wall 34 of the trailer 16. The housing 32 has a front panel 36, furthest from the front wall 34, and a top 38 and bottom 40. In a typical system, the front wall includes a mesh or grill to allow airflow into the TRU via the front wall. In many tractor-trailer systems, especially those with aerodynamic fairings, the airflow ingested through the grill is higher than ambient temperature, because the airflow often includes hot air ingestion from the tractor engine or from recirculating TRU outlet air. In the embodiments of the present disclosure, however, the front panel 36 is solid, and absent any airflow inlet. As shown in FIG. 2, airflow inlets 42 for the TRU 22 are located at the top 38 of the housing 32, and airflow outlets 44 are located at the bottom 40, or at a sidewall 46 of the housing 32. The airflow inlet 42 location at the top 38 of the housing 32 prevents hot air ingestion from the tractor engine or from recirculating TRU outlet air.

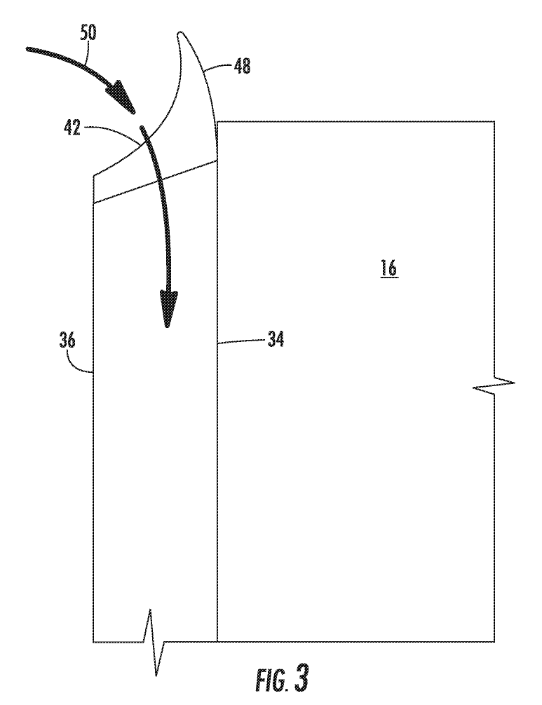

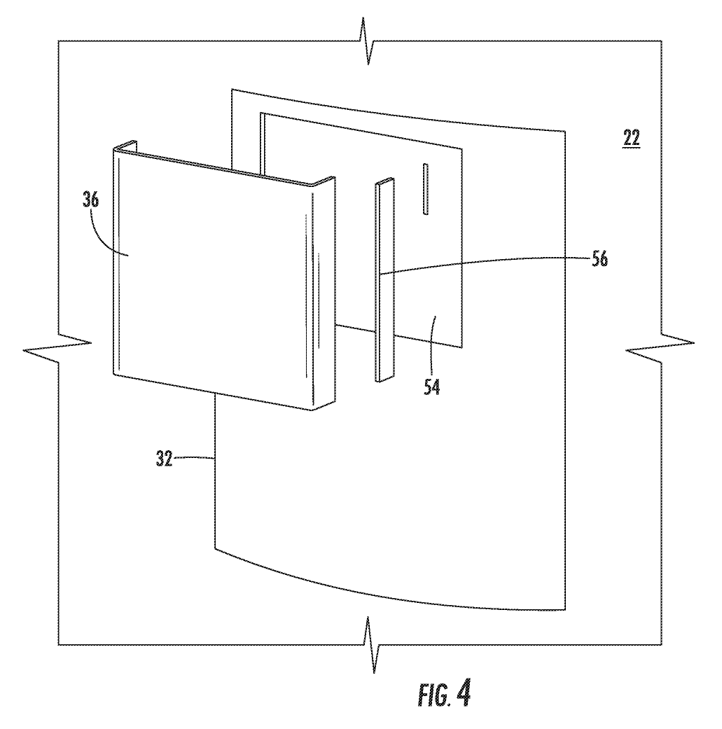

In some embodiments, as shown in FIG. 3, the airflow inlets 42 may include scoops 48 to divert and guide passing ambient airflow 50 into the airflow inlets 42. In some embodiments, such as the embodiment of FIG. 4, the front panel 36 is installed over an existing condenser air mesh 54 of the TRU 22, instead of replacing the condenser air mesh as in, for example, the embodiment of FIG. 2. The front panel 36 is secured over the econdenser air mesh 54 via, for example, a frame 56. The embodiment of FIG. 4 may be removed and installed as selected by a user, and may be added as an accessory after initial production of the TRU.

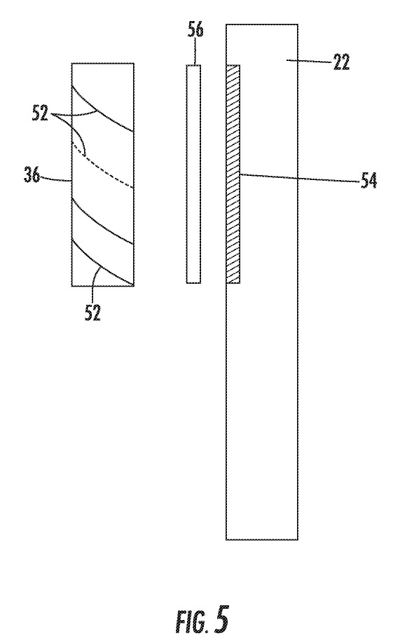

Referring now to FIG. 5, in some embodiments, the front panel 36 may include additional features, such as baffles 52, ribs or other such elements to guide airflow from the airflow inlets 42 to selected portions of the TRU 22, for example, the condenser. The baffles 52 are located between the front panel 36 and the TRU 22. In some embodiments, the baffles 52 are perforated, are mesh or otherwise include openings to allow airflow diffusion prior to entering the condenser. A solid baffle 52 may extend across the airflow inlet 42 at a bottom of the airflow inlet 42 to finally direct the airflow into the condenser. Further, additional outlet baffles may be utilized to guide exhaust airflow toward the airflow outlets 44. In one embodiment, the front panel 36 is formed from a plastic material by, for example, injection molding, blow molding or thermoforming. In some embodiments, scoops 46, baffles 52 and/or outlet baffles are formed integral to the front panel 36. Alternatively, the scoops 48, baffles 52 and/or outlet baffles may be formed independently from the front panel 36 and assembled thereto by fasteners and/or adhesives. The front panel 36 is secured to underlying structure of the TRU 22 and/or the housing 32 via fasteners, for example, screws.

Utilizing the front panel 36 of the present disclosure prevents hot air ingestion from the tractor engine or reingestion of TRU outlet airflow into the TRU resulting in performance improvement of the TRU. Further, this improvement is accomplished without redesign of the underlying TRU. Not only is performance improved by preventing ingestion of the high-temperature airflow into the TRU, but with this configuration, condenser performance is improved due to the condenser operation being changed from a front-feed of airflow to a top-feed of airflow.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cover for a transportation refrigeration unit comprising:
a substantially solid front panel; and
one or more airflow inlet openings disposed at a top of the cover to direct an airflow from outside the cover into the transportation refrigeration unit.

2. The cover of claim 1, further comprising a top panel operably connected to the front panel, the one or more airflow inlet openings disposed at the top panel.

3. The cover of claim 1, wherein the one or more airflow inlet openings include one or more scoops to direct the airflow into the transportation refrigeration unit.

4. The cover of claim 1, further comprising one or more baffles secured to the cover to direct the airflow from the one or more airflow inlet openings to a selected portion of the transportation refrigeration unit.

5. The cover of claim 4, wherein the one or more baffles are formed integral to the cover.

6. The cover of claim 1, further comprising one or more airflow outlet openings disposed below the one or more airflow inlet openings to direct the airflow from inside the transportation refrigeration unit to outside the cover.

7. The cover of claim 6, further comprising one or more outlet baffles secured to the cover to direct the airflow from the transportation refrigeration unit to the one or more airflow outlet openings.

8. A transportation refrigeration system comprising:
a refrigeration unit operably connectible to a cargo compartment and configured to direct cooling airflow into the cargo compartment thereby cooling the cargo compartment to a selected temperature; and
a cover secured to the refrigeration unit including:
a substantially solid front panel; and
one or more airflow inlet openings disposed at a top of the cover to direct an inlet airflow from outside the cover into the refrigeration unit.

9. The system of claim 8, further comprising a top panel operably connected to the front panel, the one or more airflow inlet openings disposed at the top panel.

10. The system of claim 8, wherein the one or more airflow inlet openings include one or more scoops to direct the inlet airflow into the refrigeration unit.

11. The system of claim 8, further comprising one or more baffles secured to the cover to direct the inlet airflow from the one or more airflow inlet openings to a selected portion of the refrigeration unit.

12. The system of claim 11, wherein the one or more baffles are formed integral to the cover.

13. The system of claim 8, further comprising one or more airflow outlet openings disposed below the one or more airflow inlet openings to direct an outlet airflow from inside the refrigeration unit to outside the cover.

14. The system of claim 8, wherein the cover is installed over a condenser air mesh of the refrigeration unit.

15. A refrigerated container system comprising:
a container having a cargo compartment for transportation of a cargo; and
a transportation refrigeration unit secured to the container and including:
a refrigeration unit operably connectible to the cargo compartment and configured to direct cooling airflow into the cargo compartment thereby cooling the cargo compartment to a selected temperature; and
a cover secured to the refrigeration unit including:
a substantially solid front panel; and
one or more airflow inlet openings disposed at a top of the cover to direct an inlet airflow from outside the cover into the refrigeration unit.

16. The system of claim 15, wherein the one or more airflow inlet openings include one or more scoops to direct the inlet airflow into the refrigeration unit.

17. The system of claim 15, further comprising one or more baffles secured to the cover to direct the inlet airflow from the one or more airflow inlet openings to a selected portion of the refrigeration unit.

18. The system of claim 17, wherein the one or more baffles are formed integral to the cover.

19. The system of claim 15, further comprising one or more airflow outlet openings disposed below the one or more airflow inlet openings to direct an outlet airflow from inside the refrigeration unit to outside the cover.

20. The system of claim 15, wherein the cover is installed over a condenser air mesh of the refrigeration unit.
